(19) United States
(12) Patent Application Publication
(10) Pub. No.: US 2017/0132574 A1
(43) Pub. Date: May 11, 2017

(54) Apparatus management method, apparatus management device and non-transitory computer readable storage media

(71) Applicant: INDUSTRIAL TECHNOLOGY RESEARCH INSTITUTE, Chutung (TW)

(72) Inventors: Bo-Ru WU, New Taipei City (TW); Yu-Hung TSENG, Zhubei City (TW)

(21) Appl. No.: 14/757,477

(22) Filed: Dec. 23, 2015

(30) Foreign Application Priority Data
Nov. 11, 2015 (TW) 104137205

(51) Int. Cl. G06Q 10/10; H04W 4/00; H04L 9/30

(52) U.S. Cl. CPC G06Q 10/1095; H04L 9/30; H04W 4/008

(57) ABSTRACT

An apparatus management method, an apparatus management device and a non-transitory computer readable storage media are disclosed. The apparatus management method includes following steps. Receive user information and an indicated project at a schedule reservation stage. At least one executable item of the indicated project is in executive order. At least one executable item corresponds to at least one preset apparatus. Determine whether at least one selectable schedule corresponding to a reservation record of the at least one preset apparatus exists. Determine whether a first indicator is received when the at least one selectable schedule exists. The first indicator indicates one of the at least one selectable schedule. Adaptively authorize one of the at least one preset apparatus according to a preset time, the user information and the reservation record of the selectable schedule indicated by the first indicator at a schedule execution stage.

### CROSS-REFERENCE TO RELATED APPLICATIONS

This non-provisional application claims priority under 35 U.S.C. §119(a) on Patent Application No(s). 104137205 filed in Taiwan, R.O.C. on Nov. 11, 2015, the entire contents of which are hereby incorporated by reference.

### TECHNICAL FIELD

The disclosure relates to an apparatus management method, an apparatus management device and a non-transitory computer readable storage media.

### BACKGROUND

The development of technology has caused that more and more modern apparatuses, such as exercise apparatuses, medical apparatuses or a variety of types of apparatus, are produced to provide people with a variety of services.

In a case of an exercise process in a fitness center, a specific exercise project relates to multiple specific exercise apparatuses, and these exercise apparatuses can provide a user with trainings of different levels. In a case of health examination, a specific checkout project relates multiple specific medical apparatuses, and these medical apparatuses can provide a user with physical examinations of different levels.

Although a great deal of hardware resources has existed, the existing hardware resources may not reach the best benefits when a great deal of people is using the hardware resources at the same time or an error occurs to the workflow. Alternatively, once the management of apparatuses is out of order and then results in that someone uses an apparatus with permission or that an apparatus is improperly operated, a safety problem may occur.

### SUMMARY

According to one or more embodiments, the disclosure provides an apparatus management method applied to a server and including the following steps. At a schedule reservation stage, receive user information and an indicated project. The indicated project is related to at least one executable item and at least one preset apparatus, the at least one executable item is in executive order, and the at least one executable item in the indicated project corresponds to the at least one preset apparatus. Determine whether there is at least one selectable schedule related to the at least one executable item, according to a reservation record of the at least one preset apparatus. The at least one executable item in the selectable schedule corresponds to the at least one preset apparatus. When the at least one selectable schedule exists, determine whether a first indicator for indicating one of the at least one selectable schedule is received. At a schedule execution stage, adaptively authorize the at least one preset apparatus in the selectable schedule indicated by the first indicator according to a current time, the user information and the reservation record of the at least one preset apparatus in the selectable schedule indicated by the first indicator.

According to one or more embodiments, the disclosure provides an apparatus management device applied to a server. The apparatus management device includes a schedule reservation module and an apparatus authorization module. The apparatus authorization module is coupled to the schedule reservation module. The schedule reservation module receives user information and an indicated project at a schedule reservation stage. The indicated project is related to at least one executable item and at least one preset apparatus. The at least one executable item is in executive order, and the at least one executable item in the indicated project corresponds to the at least one preset apparatus. The schedule reservation module also, according to a reservation record of the at least one preset apparatus, determines whether at least one selectable schedule corresponding to the at least one executable item exists. The at least one executable item in each selectable schedule corresponds to the at least one preset apparatus. When at least one selectable schedule exists, the schedule reservation module determines whether a first indicator for indicating one of the at least one selectable schedule is received. The apparatus authorization module adaptively authorizes each preset apparatus in a selectable schedule indicated by the first indicator according to a current time, the user information and a reservation record of each preset apparatus in the selectable schedule indicated by the first indicator, at a schedule execution stage.

According to one or more embodiments, the disclosure provides an apparatus management method applied to a mobile device and including the following steps. At a schedule reservation stage, log in a server using user information to select an indicated project related to at least one executable item and at least one preset apparatus. The at least one executable item is in executive order, and in the indicated project, the at least one executable item corresponds to the at least one preset apparatus. Send a first indicator to select one of the at least one selectable schedule corresponding to the indicated project. The at least one executable item in each selectable schedule corresponds to the at least one preset apparatus. At a schedule execution stage, send a starting request to an apparatus to determine whether the apparatus is authorized to start because of matching the selectable schedule indicated by the first indicator. Operate the apparatus by the mobile device when the apparatus is authorized to start because of matching the selectable schedule indicated by the first indicator.

According to one or more embodiments, the disclosure provides a non-transitory computer readable storage media having a program of performing the aforementioned apparatus management method applied to the mobile device.

According to one or more embodiments, the disclosure provides an apparatus management method applied to an apparatus and including the following steps. Receive a starting request from a mobile device. In response to the starting request, use the mobile device to communicate with a server in order to determine whether the apparatus matches a selectable schedule indicated by a first indicator. Start the apparatus when the apparatus matches the selectable schedule indicated by the first indicator. The first indicator is received by the server in order to indicate the selectable schedule. The selectable schedule indicated by the first indicator is related to at least one executable item. The at least one executable item is in executive order and the at least one executable item corresponds to a preset apparatus.

According to one or more embodiments, the disclosure provides an apparatus management device for an apparatus. The apparatus management device includes a near field communication module, an authority determination module and an apparatus enabling module. The near field communication module receives a starting request from a mobile device and in response to the starting request, communicates with a server through the mobile device. The authority determination module is coupled to the near field communication module and according to a communication result, determines whether the apparatus matches a selectable schedule indicated by a first indicator. When the apparatus matches the selectable schedule indicated by the first indicator, the authority determination module generates an enabling signal. The apparatus enabling module is coupled to the authority determination module and starts the apparatus when receiving the enabling signal. The first indicator is received by the server in order to indicate the selectable schedule. The selectable schedule indicated by the first indicator is related to at least one executable item, and the at least one executable item is in executive order. The at least one executable item corresponds to a preset apparatus.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic view of the operation of a mobile device between a server and an apparatus in an embodiment;

FIG. 2 is a block diagram of an apparatus management device for a server in an embodiment;

FIG. 3 is a block diagram of an apparatus management device for an apparatus in an embodiment;

FIG. 4A and FIG. 4B illustrate a flow chart of an apparatus management method in an embodiment;

FIG. 5A and FIG. 5B are schematic views of operation interfaces in an embodiment;

FIG. 6A˜FIG. 6F are schematic views of selectable schedules in an embodiment;

FIG. 7 is a schematic view of an apparatus in an embodiment;

FIG. 8 is a flow chart of an apparatus management method applied to a server in another embodiment;

FIG. 9 is a flow chart of an apparatus management method applied to a mobile device in another embodiment; and

FIG. 10 is a flow chart of an apparatus management method applied to an apparatus in another embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

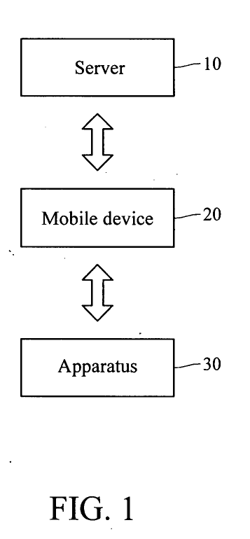

FIG. 1 is a schematic view of the operation of a mobile device 20 between a server 10 and an apparatus 30 in an embodiment. The server 10 is, for example, but not limited to, a cloud server or a physical server. The mobile device 20 is, for example, but not limited to, a smart phone, a personal digital assistant (PDA), a tablet computer or other portable electronic device. The apparatus 30 is, for example, but not limited to, an exercise apparatus, a medical device or other type apparatuses.

To clarify the disclosure, the apparatus 30 is exemplified by an exercise apparatus as described below. For example, when a user attempts to execute a weight loss plan, the user can use the mobile device 20 to log in the server 10 belonging to a sport center in order to search for an exercise program the user prefers. If the user chooses a specific exercise program, the server 10 will allocate a reserved usage period for the apparatus 30 corresponding to this choice. Accordingly, when the user visits the sport center, the user can employ the assistance of the mobile device 20 to start the relative apparatus 30, thereby executing the weight loss plan. This process will be described in detail later.

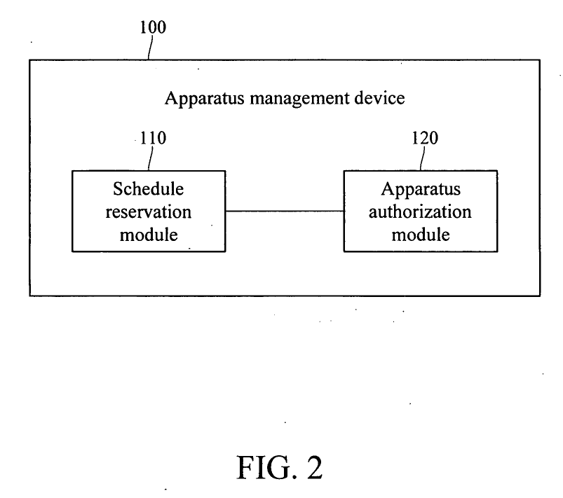

FIG. 2 is a block diagram of an apparatus management device 100 for the server 10 in an embodiment. The apparatus management device 100 includes a schedule reservation module 110 and an apparatus authorization module 120. The apparatus authorization module 120 is coupled to the schedule reservation module 110. The schedule reservation module 110 and the apparatus authorization module 120 are, for example, but not limited to, a variety of chips or a variety of microprocessors.

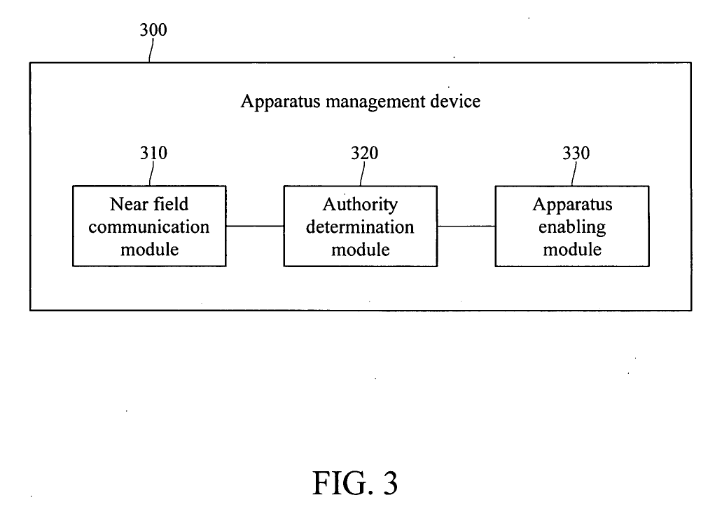

FIG. 3 is a block diagram of an apparatus management device 300 for the apparatus 30 in an embodiment. The apparatus management device 300 includes a near field communication module 310, an authority determination module 320 and an apparatus enabling module 330. The authority determination module 320 is coupled to the near field communication module 310, and the apparatus enabling module 330 is coupled to the authority determination module 320. The near field communication module 310, the authority determination module 320 and the apparatus enabling module 330 are, for example, but not limited to, a variety of chips or a variety of microprocessors.

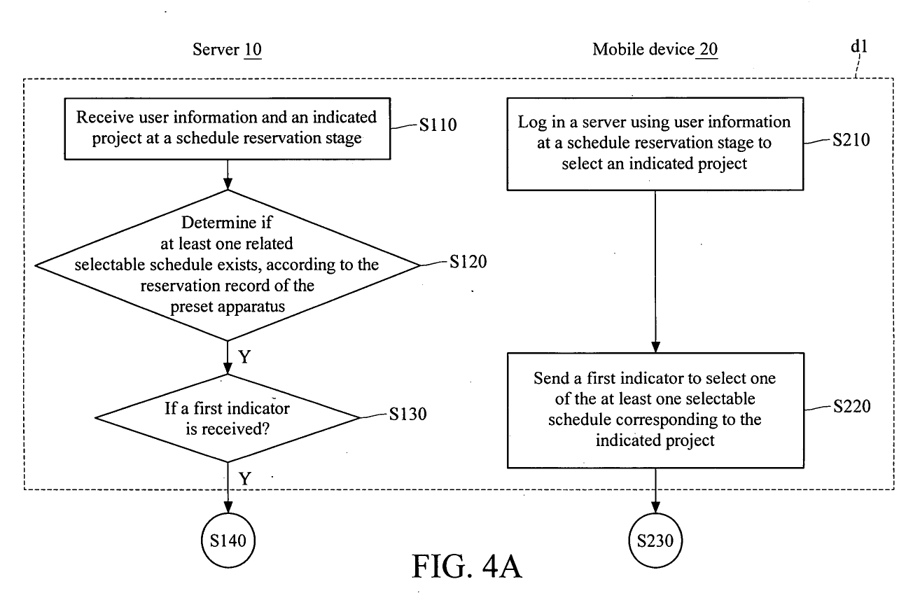

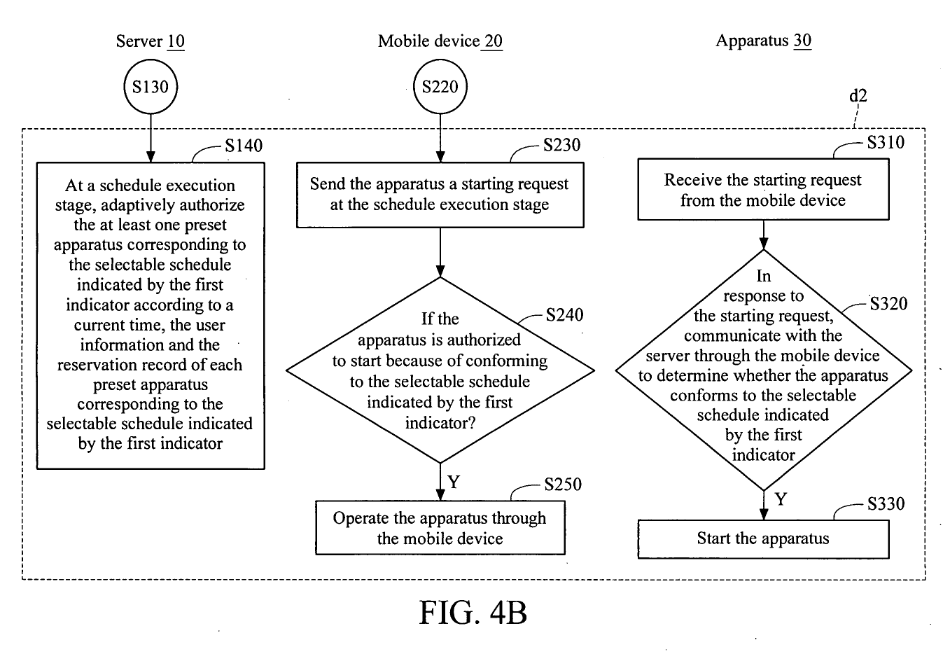

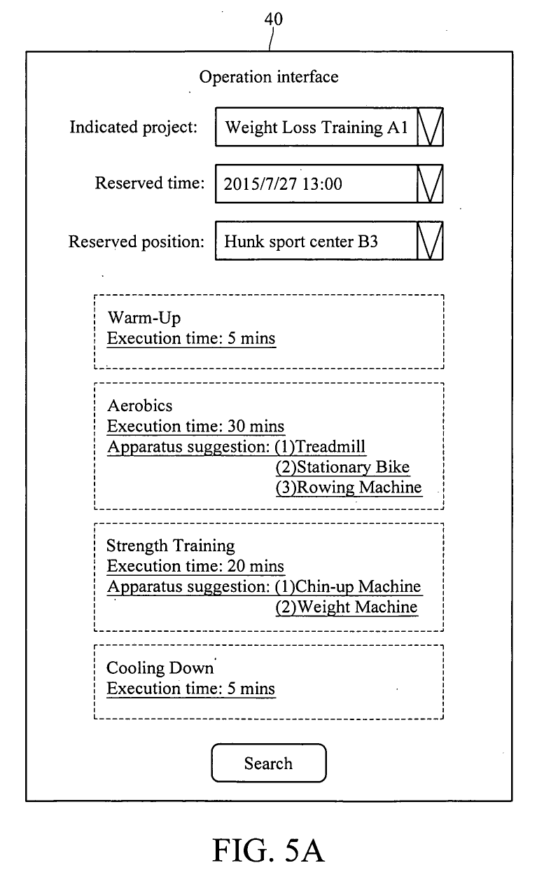

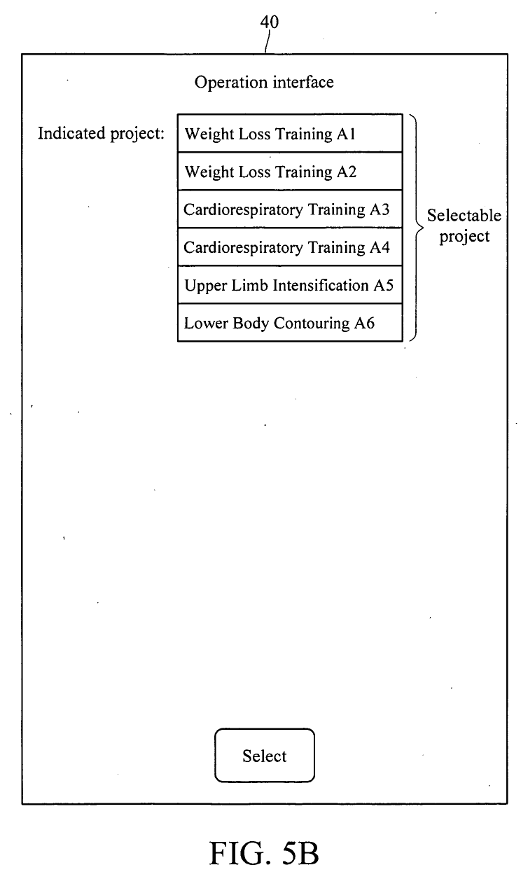

FIG. 4A and FIG. 4B illustrate a flow chart of an apparatus management method in an embodiment. A fraction of the apparatus management method is applied to the server 10 and includes steps S110˜S140, a fraction of the apparatus management method is applied to the mobile device 20 and includes steps S210˜S250, and a fraction of the apparatus management method is applied to the apparatus 30 and includes steps S310˜S330. Each of these steps belongs to either a schedule reservation stage d1 or a schedule execution stage d2. FIG. 5A and FIG. 5B are schematic views of an operation interface 40 in an embodiment. Please refer to FIGS. 1˜3, 4A˜4B and 5A˜5B.

In step S210, at the schedule reservation stage d1, the mobile device 20 logs in the server 10 using user information to select an indicated project. The indicated project is related to one or more executable items and one or more preset apparatuses, the one or more executable items are in executive order, and in the indicated project, at least one of the one or more executable items corresponds to at least one of the one or more preset apparatuses. Correspondingly, in step S110 at the schedule reservation stage d1, the schedule reservation module 110 in the server 10 can receive the user information and the indicated project inputted by the mobile device 20. In an embodiment, a user can use the mobile device 20 to log in the operation interface 40 provided by the server 10, to select the indicated project.

For example, the user information is, for example, but not limited to, a membership ID and a related password which the user has registered in a sport center. After the user logs in the server 10 of the sport center, the user will be allowed to select an indicated project “Weight Loss Training A1”, as shown in FIG. 5A. The indicated project “Weight Loss Training A1” is related to a plurality of executable items, such as “Warm-Up”, “Aerobics”, “Strength Training” and “Cooling Down”, as shown in FIG. 5A. The executable items are designed according to the physical condition, physical ability, health or other related indexes of a user. Also, the one or more executable items are in executive order so the user may get a best exercise effect.

Moreover, one executable item corresponds to an execution time. For example, the execution time for the executable item “Warm-Up” is 5 mins, the execution time for the executable item “Aerobics” is 30 mins, the execution time for the executable item “Strength Training” is 20 mins, and the execution time for the executable item “Cooling Down” is 5 mins.

Also, instances of preset apparatuses related to the executable item “Aerobics” include “Treadmill”, “Stationary Bike” and “Rowing Machine”, instances of preset apparatus related to the executable item “Strength Training” include “Chin-up Machine” and “Weight Machine”. The executable items of “Warm-Up” and “Cooling Down” can be done without any preset apparatus.

In an embodiment, the schedule reservation module 110 in the server 10 shows at least one preset apparatus corresponding to each executable item on the operation interface 40 according to an apparatus recommend order. Accordingly, the user can refer to the apparatus recommend order presented on the operation interface 40 for the follow-up selection (i.e. giving a first indicator for indicating a selectable schedule). As described in FIG. 5A, among the preset apparatuses related to the executable item “Aerobics”, “Treadmill” has the first position in the apparatus recommend order, “Stationary Bike” has the second position in the apparatus recommend order, and “Rowing Machine” has the third position in the apparatus recommend order. Among the preset apparatuses related to the executable item “Strength Training”, “Chin-up Machine” has the first position in the apparatus recommend order, and “Weight Machine” has the second position in the apparatus recommend order. The above apparatus recommend order can be designed according to the rate of target completion of each of the one or more executable items, or according to the physical condition, physical ability, health or other related indexes of a user.

In an embodiment, before the indicated project is selected, the server 10 can show multiple selectable projects, such as “Weight Loss Training A1”, “Weight Loss Training A2”, “Cardiorespiratory Training A3”, “Cardiorespiratory Training A4”, “Upper Limb Intensification A5” and “Lower Body Contouring A6”, on the operation interface 40, as shown in FIG. 5B. Accordingly, the user may employ the mobile device 20 to send a second indicator through the operation interface 40 to indicate one of the selectable projects as the indicated project. For example, when the user selects “Weight Loss Training A1” and then presses the key “Select” as shown in FIG. 5B, such a second indicator will be sent out. Then, the server 10 determines whether any second indicator is received through the operation interface 40. When the second indicator is received through the operation interface 40, such a selectable project indicated by the second indicator will be set as the indicated project. In other words, if “Weight Loss Training A1” is selected and then the key “Select” is selected as shown in FIG. 5B, “Weight Loss Training A1” will be set as the indicated project.

Additionally, in an embodiment, the user can give more search conditions, such as setting of a reserved time and the setting of a reserved position, in the operation interface 40 so the server 10 will receive them. For example, as shown in FIG. 5A, after the user selects the indicated project “Weight Loss Training A1”, the user can further select a reserved time “2015/7/27 13:00” and a reserved position “Hunk sport center B3” so the search result may more fit in the user's real situation.

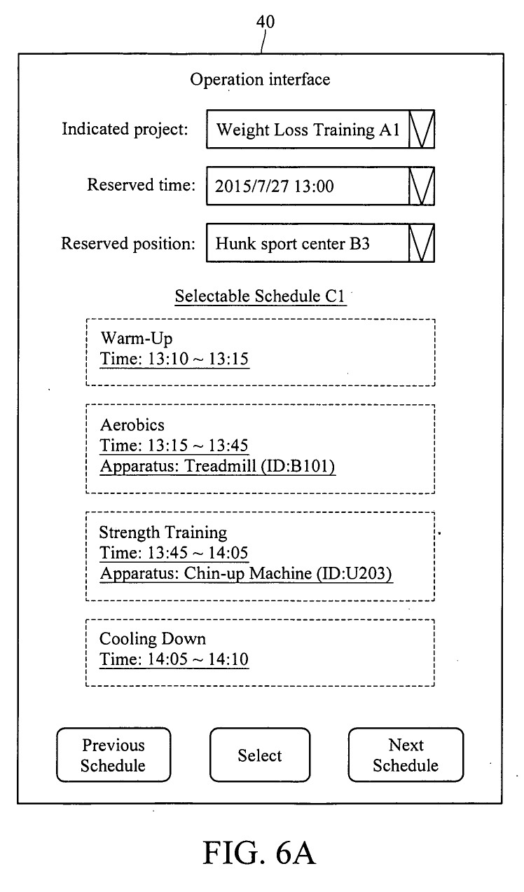

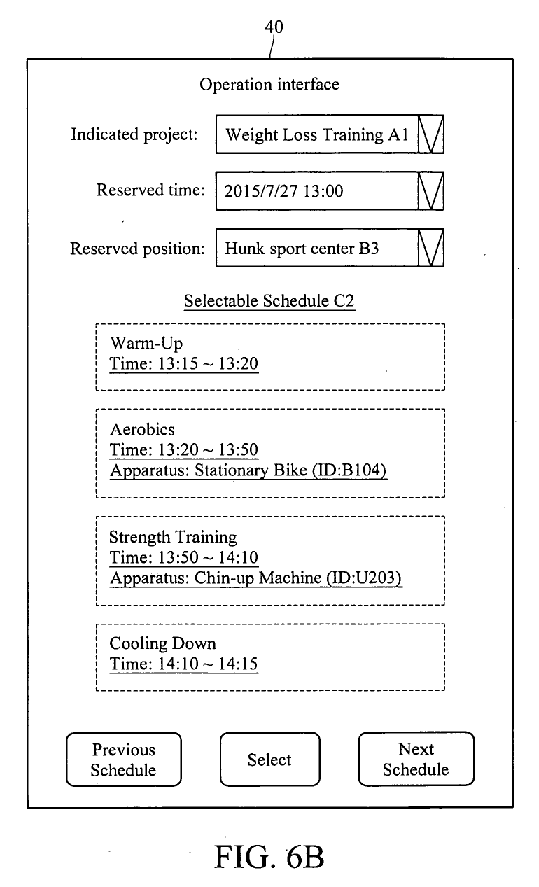

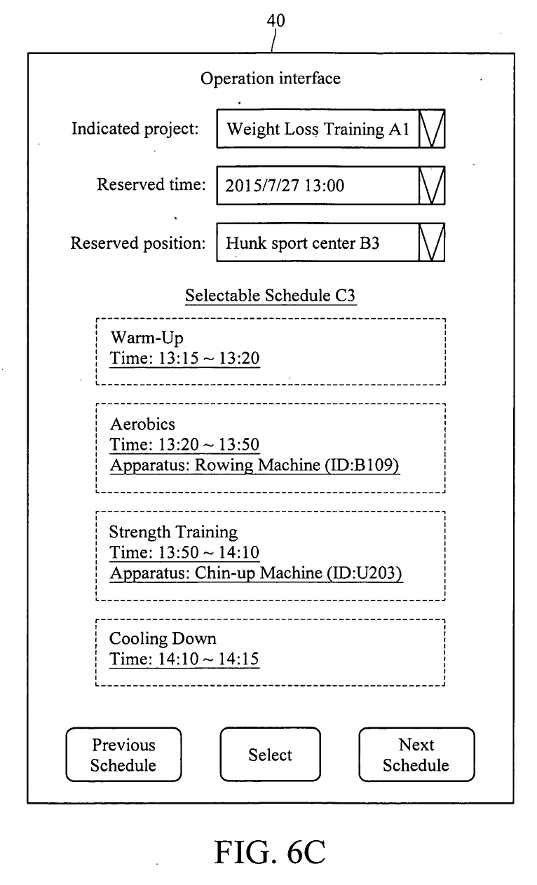

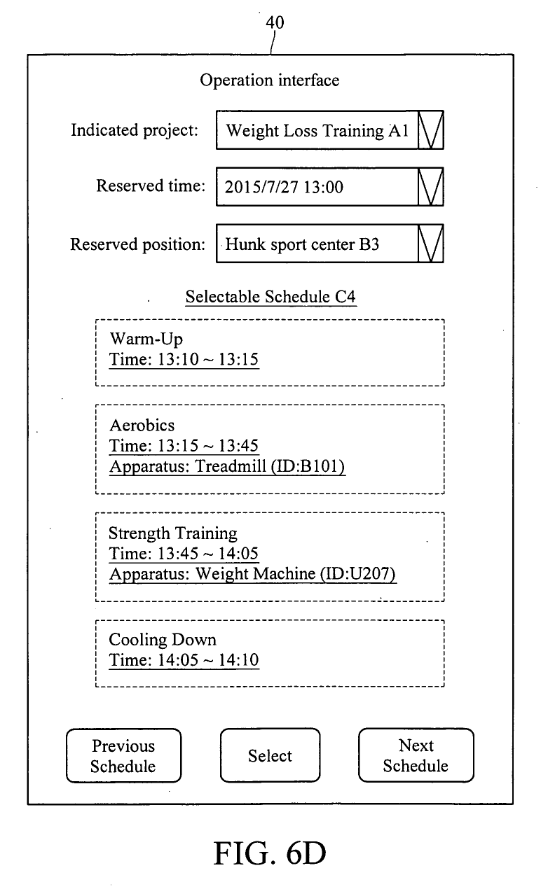

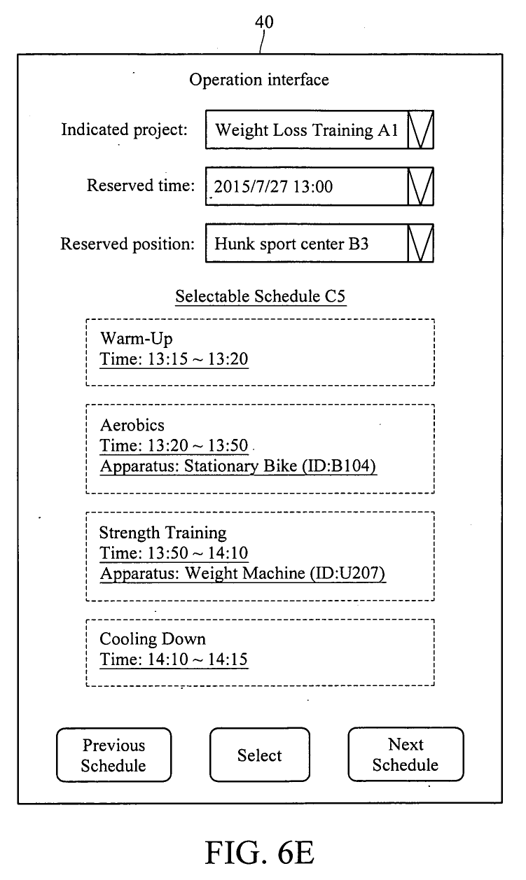

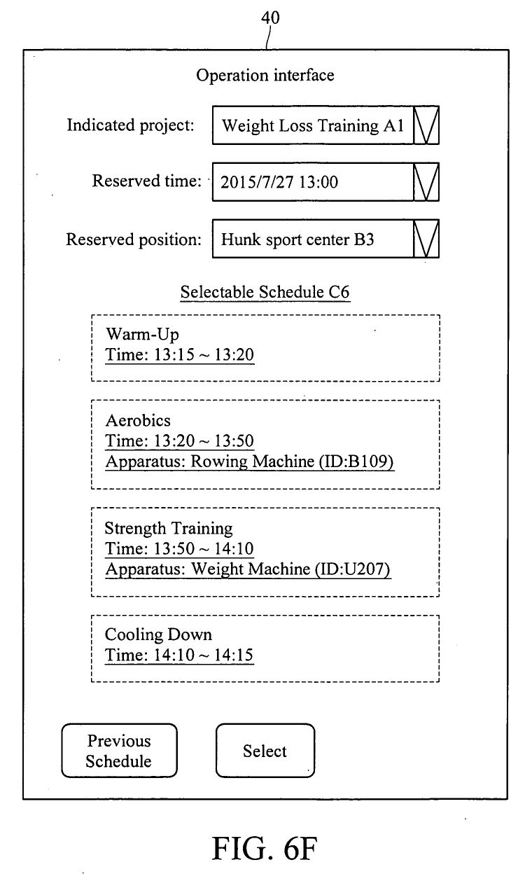

FIG. 6A˜FIG. 6F are schematic views of selectable schedules in an embodiment. Please refer to FIGS. 1˜3, 4A˜4B, 5A˜5B and 6A˜6F to describe the selectable schedules.

In step S120, the schedule reservation module 110 in the server 10 also, according to a reservation record of each preset apparatus, determines at least one selectable schedule corresponding to the one or more executable items exists. At least one of the one or more executable items in each selectable schedule corresponds to one of the one or more preset apparatuses. In an embodiment, the schedule reservation module 110 further, according to the reserved time, the reserved position and the execution time of each of the one or more executable items, determines at least one selectable schedule exists.

For example, as shown in FIGS. 6A˜6F, the schedule reservation module 110 in the server 10, according to each executable item corresponding to the indicated project “Weight Loss Training A1” and the arrangement and combination of the preset apparatuses in each executable item, generates selectable projects C1˜C6 for the user to select. In the duration of generating the selectable schedules C1˜C6, the reservation record corresponding to each preset apparatus should be a concern. In other words, as described in an example with respect to the selectable schedule C1 in FIG. 6A, the schedule reservation module 110 has to ensure that nobody reserves a specific treadmill (ID:B101) in the reserved position “Hunk sport center B3” during at least 30 mins (e.g. the execution time of the executable item “Aerobics” is 30 mins) in the duration of 90 mins which is later than a reserved time “2015/7/27 13:00”, and nobody reserves a specific chin-up machine (ID:U203) during at least 20 mins (i.e. the execution time of the executable item “Strength Training” is 20 mins) after the executable item “Aerobics” has down. Such a length of time of 90 mins is an allowable latency preset by the schedule reservation module 110.

Specifically, in an embodiment, the schedule reservation module 110 has a queue. Before the above selectable schedules C1˜C6 are generated, the schedule reservation module 110 puts the schedules for all the related reserved times and the related reserved positions into the queue by the first-in-first-out (FIFO) method. The executable item corresponding to one or more preset apparatuses corresponding to the schedule early put into the queue has a relatively high priority in the apparatus recommend order. The schedule reservation module 110 reads out the schedules from the queue one by one to compare the read-out schedule with a reservation record of a preset apparatus, so as to determine whether the schedule read out from the queue can be the aforementioned selectable schedule.

As described in FIG. 6A, if the schedule reservation module 110 determines that the treadmill (ID:B101) is not reserved during the time period between 13:15 and 13:45 in that day and the chin-up machine (ID:U203) is neither reserved during the time period between 13:45 and 14:05 in that day, the schedule reservation module 110 will generate such a selectable schedule C1 in response.

Similarly, as described in FIG. 6B, if the schedule reservation module 110 determines that a stationary bike (ID:B104) is not reserved during the time period between 13:20 and 13:50 in that day and the chin-up machine (ID:U203) is not reserved during the time period between 13:50 and 14:10, the schedule reservation module 110 will generate a selectable schedule C2 in response. Since the executable items “Warm-Up” and “Cooling Down” can be executed without any preset apparatus, the onset time can be scheduled flexibly.

The processes of generating the selectable schedules C3˜C6 are similar to the above process of generating the selectable schedule C1 and thus, will not be repeated hereinafter.

In step S220, a first indicator for selecting one of the at least one selectable schedule is sent out by, for example, the mobile device 20 or other device according to at least one selectable schedule corresponding to the indicated project. As described in FIGS. 6A˜6F, a user can press a key “Next Schedule” or “Previous Schedule” on the operation interface 40 for looking for; and when attempting to indicate one of the selectable schedules C1˜C6, the user can press the key “Select” corresponding the selectable schedule indicated by the first indicator, to send a first indicator, thereby carrying out the selection of selectable schedule.

Accordingly, in step S130, when the schedule reservation module 110 in the server 10 determines that at least one selectable schedule exists, the schedule reservation module 110 will further determine whether the first indicator is received in the operation interface. In an embodiment, when receiving the first indicator, the schedule reservation module 110 will update the reservation record of each preset apparatus corresponding to the selectable schedule indicated by the first indicator according to the user information, the reserved time, the reserved position and the execution time of each of the one or more executable items. In other words, the schedule reservation module 110 will assign a specific preset apparatus at a specific position to only one specific user during a specific time period. That is, only a certain user, who has selected a certain selectable schedule, can use a specific preset apparatus at a specific position during a scheduled time indicated by the selectable schedule indicated by the first indicator, and the related reservation information will be recorded in the reservation record corresponding to the related preset apparatus.

In this embodiment, the user uses the mobile device 20 to link to the server 10 for the operation at the schedule reservation stage d1. Other embodiments may be contemplated in which the user uses a personal computer or another non-portable electronic device to link to the server 10 for the operation at the schedule reservation stage d1.

Then, in step S140, the apparatus authorization module 120 in the server 10 at the schedule execution stage d2 adaptively authorizes each preset apparatus corresponding to the selectable schedule indicated by the first indicator according to a current time, the user information and the reservation record of each preset apparatus corresponding to the selectable schedule indicated by the first indicator. In other words, when the user is using the apparatus 30 through the mobile device 20, the apparatus authorization module 120 has to first confirm that all the related time, position and user (or the mobile device 20) and the apparatus 30 are conforming to the above selectable schedule indicated by the first indicator, and then gives an authority.

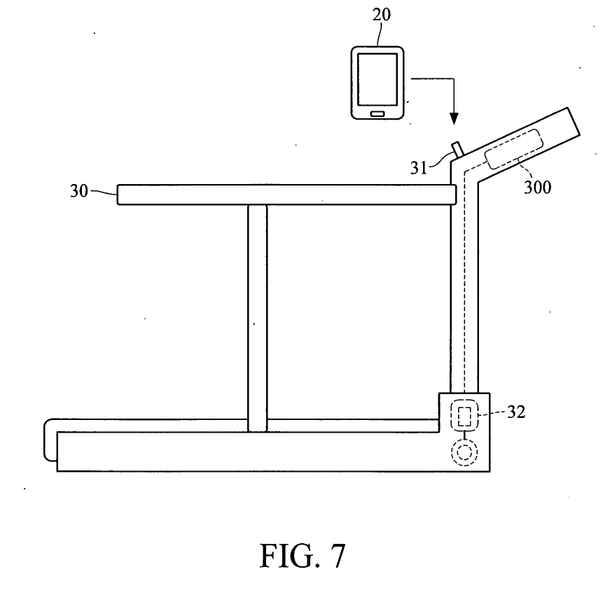

FIG. 7 is a schematic view of the apparatus 30 in an embodiment. The apparatus 30 includes an apparatus management device 300, a docking stand 31 and a driving motor 32. The following description can refer to FIGS. 1˜3, 4A˜4B and 7.

In step S230, at the schedule execution stage d2, the mobile device 20 sends the apparatus 30 a starting request. For example, a user may put the mobile device 20 on the docking stand 31, so as to establish a communication between the mobile device 20 and the near field communication module 310 in the apparatus management device 300 to send the starting request.

Accordingly, in step S310, the near field communication module 310 receives the starting request from the mobile device 20 and according to the starting request, communicates with the server 10 through the mobile device 20. In step S320, the authority determination module 320, according to the communication result, determines whether the apparatus 30 conforms to the selectable schedule indicated by the first indicator; and when it is determined that the apparatus 30 conforms to the selectable schedule indicated by the first indicator, the authority determination module 320 outputs an enabling signal. In step S330, when receiving the enabling signal, the apparatus enabling module 330 starts the apparatus 30. For example, the apparatus enabling module 330 controls the connection between a power source and the driving motor 32; and when receiving the enabling signal, the apparatus enabling module 330 enables the connection between the power source and the driving motor 32 so the user can execute the related executable item on the apparatus 30. In another embodiment, the apparatus 30 also includes a lock mechanism and an unlocking mechanism; when not receiving the enabling signal, the apparatus 30 is locked; and upon receipt the enabling signal, the apparatus 30 is unlocked.

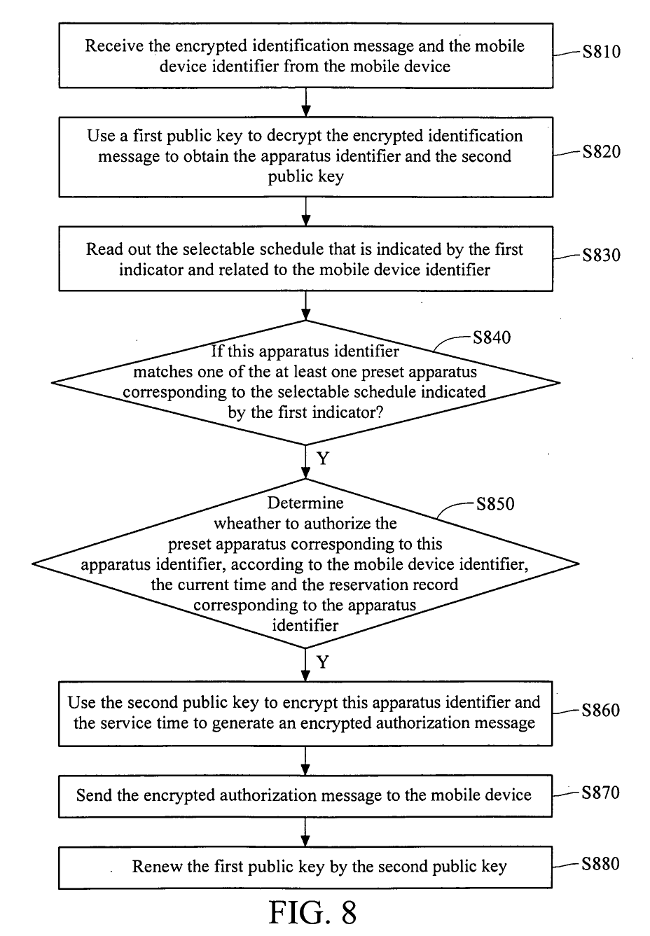

The process of generating the above communication result and the other detailed operation at the schedule execution stage d2 will be described later with respect to FIGS. 8˜10.

In step S240, the mobile device 20 determines whether the apparatus 30 is authorized to start because of conforming to the selectable schedule indicated by the first indicator. In step S250, the user operates the apparatus 30 through the mobile device 20. Specifically, the near field communication module 310 can detect whether the mobile device 20 is still on the docking stand 31, whereby the apparatus enabling module 330 can determine whether to keep the apparatus 30 enabled.

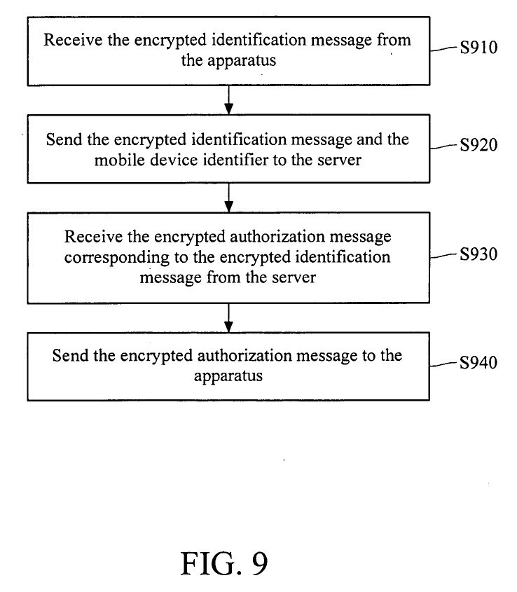

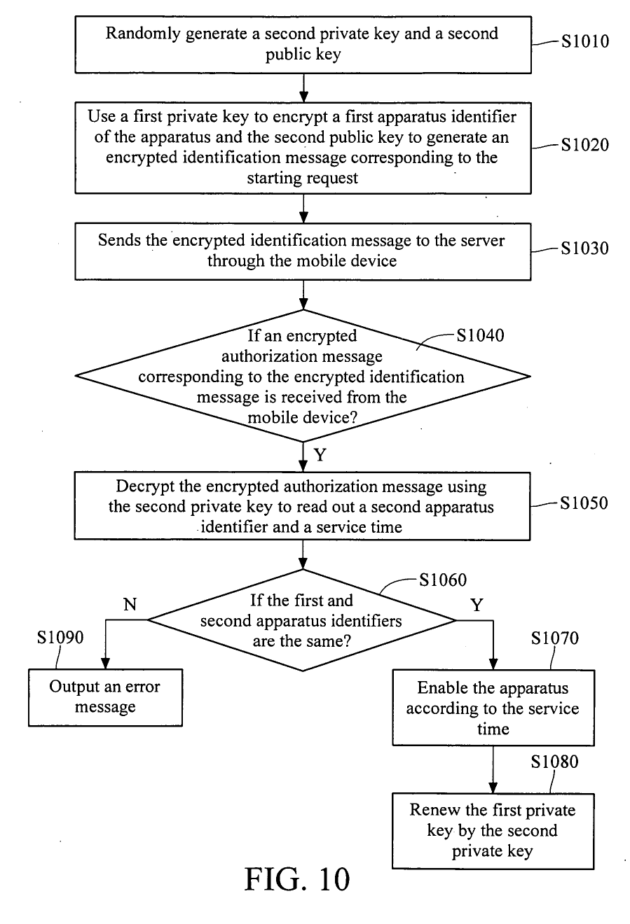

FIG. 8 is a flow chart of an apparatus management method applied to the server 10 in another embodiment. The apparatus management method applied to the server 10 includes steps S810˜S880. FIG. 9 is a flow chart of an apparatus management method applied to the mobile device 20 in another embodiment. The apparatus management method applied to the mobile device 20 includes steps S910˜S940. FIG. 10 is a flow chart of an apparatus management method applied to the apparatus 30 in another embodiment. The apparatus management method applied to the apparatus 30 includes steps S1010˜S1090. These apparatus management methods are described below with respect to FIGS. 1˜3, FIGS. 4A˜4B and FIGS. 7˜10.

After a user finishes the operations at the schedule reservation stage d1, the user can go to the reserved position and execute the indicated project. To ensure that the user arriving at the reserved position uses the reserved apparatus at a right time point, the schedule execution process, which is related to a public key and a private key, will be performed among the server 10, the mobile device 20 and the apparatus 30 at the schedule execution stage d2. After the user arriving at the field puts the mobile device 20 on the docking stand 31 in FIG. 7, the starting request will be outputted to the apparatus 30.

Accordingly, in step S1010, the authority determination module 320 in the apparatus 30 randomly generates a second private key and a second public key so in step S1020, the authority determination module 320 can use a first private key to encrypt an apparatus identifier (referred to as a first apparatus identifier) of the apparatus 30 and the second public key to generate an encrypted identification message corresponding to the starting request. In step S1030, the authority determination module 320 sends the encrypted identification message to the mobile device 20 through the near field communication module 310 and then the mobile device 20 transfers the encrypted identification message to the server 10, as described below in step S910 and S920.

In step S910, the mobile device 20 receives the encrypted identification message from the near field communication module 310.

In step S920, the mobile device 20 sends the encrypted identification message and a mobile device identifier to the server 10. In an embodiment, the user information is related to the mobile device identifier of the mobile device 20, that is, the identification information about the user is binding on the mobile device 20 of the user so that when the user visiting a sport center puts the mobile device 20 on the docking stand 31 on the apparatus 30, the schedule execution process at the schedule execution stage d2 will immediately be executed automatically.

Accordingly, in step S810, the apparatus authorization module 120 in the server 10 receives the encrypted identification message and the mobile device identifier of the mobile device 20 from the mobile device 20. Then, in step S820, a first public key is used to decrypt the encrypted identification message to obtain the apparatus identifier of the apparatus 30 and the second public key. In step S830, the apparatus authorization module 120 reads out the selectable schedule that is indicated and related to the mobile device identifier. In step S840, the apparatus authorization module 120 determines whether this apparatus identifier matches one of the at least one preset apparatus corresponding to the selectable schedule that is indicated.

Then, in step S850, when the apparatus identifier of the apparatus 30 matches one of the at least one preset apparatus corresponding to the selectable schedule that is indicated, the apparatus authorization module 120 will, according to the mobile device identifier, the current time, and the reservation record corresponding to the apparatus identifier, determines whether to authorize the preset apparatus corresponding to this apparatus identifier. In step S860, when it is determined to authorize the preset apparatus corresponding to the apparatus identifier, the second public key will be used to encrypt this apparatus identifier and a service time to generate an encrypted authorization message. The service time herein is related to the reservation record of the preset apparatus related to the apparatus identifier. Next, in step S870, the encrypted authorization message is sent to the mobile device 20. In step S880, the first public key is renewed by the second public key. After that, the mobile device 20 performs the steps as described below.

In step S930, the mobile device 20 receives the encrypted authorization message corresponding to the encrypted identification message from the server 10.

In step S940, the mobile device 20 sends the encrypted authorization message to the apparatus 30. When the apparatus 30 is authorized by the server 10 because of matching the selectable schedule indicated by the user through the mobile device 20, the apparatus 30 will be started in response to the received encrypted authorization message. This will be described below in detail.

In accordance with step S940, the authority determination module 320 determines whether an encrypted authorization message corresponding to the encrypted identification message is received from the mobile device 20, as described in step S1040. In step S1050, when receiving the encrypted authorization message corresponding to the encrypted identification message from the mobile device 20, the authority determination module 320 will decrypt the encrypted authorization message using the second private key to read out another apparatus identifier (referred to as a second apparatus identifier) and a service time. In step S1060, the authority determination module 320 determines whether the second apparatus identifier conforms to the apparatus identifier (i.e. the first apparatus identifier) of the apparatus 30.

Note that if some unexpected situations, such as a malicious login to a server, the fraudulent use of an apparatus, a damage to an apparatus, or the out-of-order replacing of an apparatus, occur, another apparatus identifier (i.e. the second apparatus identifier) obtained during the decryption for the apparatus 30 may be different from the apparatus identifier (i.e. the first apparatus identifier) of the apparatus 30. Therefore, in step S1070, when the second apparatus identifier is the same as the first apparatus identifier, the authority determination module 320 will generate an enabling signal according to the service time, and the apparatus enabling module 330 enables the apparatus 30 according to the enabling signal. As described above, the service time is related to the reservation record of the apparatus. Finally, in step S1080, the authority determination module 320 renews the first private key by the second private key. When the second apparatus identifier is different from the first apparatus identifier, the authority determination module 320 will output an error message in step S1090.

Therefore, the authentication of the mobile device identifier and the apparatus identifier performed by the server 10, the encryption and decryption of data transmitted between the server 10 and the apparatus 30 using public keys and private keys, and the updating of public keys and private keys may more ensure the correction and safety during the entire process.

In an embodiment, the disclosure also provides a non-transitory computer readable storage media in which a program is stored. The program is executed by the mobile device 20 to carry out the apparatus management method.

As set forth above, at the schedule reservation stage, the server provides a user with multiple selectable schedules in the indicated project conforming to one or more reservation conditions for selection, and updates the reservation record corresponding to the related preset apparatus. Therefore, at the schedule execution stage, the communication of encrypted messages among the mobile device, the apparatus and the server decides whether to start the apparatus, so as to adaptively authorize at least one preset apparatus corresponding to the selectable schedule that is indicated.

What is claimed is:

1. An apparatus management method applied to a server and comprising:
at a schedule reservation stage, receiving user information and a indicated project related to at least one executable item and at least one preset apparatus, the at least one executable item being in executive order, and the at least one executable item in the indicated project corresponding to the at least one preset apparatus;
determining whether there is at least one selectable schedule related to the at least one executable item according to a reservation record of each of the at least one preset apparatus, and the at least one executable item in the selectable schedule corresponding to one of the at least one preset apparatus;
when there is the at least one selectable schedule, determining whether a first indicator for indicating one of the at least one selectable schedule is received; and
at a schedule execution stage, adaptively authorizing the at least one preset apparatus in the selectable schedule indicated by the first indicator according to a current time, the user information and the reservation record of each of the at least one preset apparatus in the selectable schedule indicated by the first indicator.

2. The apparatus management method according to claim 1, wherein the user information is related to a mobile device identifier of a mobile device, and at the schedule execution stage, adaptively authorizing each of the at least one preset apparatus in the selectable schedule indicated by the first indicator according to the current time, the user information and the reservation record of each of the at least one preset apparatus in the selectable schedule indicated by the first indicator comprises:
receiving the mobile device identifier of the mobile device and a encrypted identification message from the mobile device;
decrypting the encrypted identification message using a first public key to obtain an apparatus identifier and a second public key;
reading out the selectable schedule indicated by the first indicator and related to the mobile device identifier;
determining whether the apparatus identifier matches one of the at least one preset apparatus in the selectable schedule indicated by the first indicator;
determining whether to authorize the preset apparatus corresponding to the apparatus identifier according to the mobile device identifier, the current time and the reservation record corresponding to the apparatus identifier when the apparatus identifier matches one of the at least one preset apparatus in the selectable schedule indicated by the first indicator;
encrypting the apparatus identifier and a service time using the second public key to generate an encrypted authorization message when it is determined to authorize the preset apparatus corresponding to the apparatus identifier, wherein the service time is related to the reservation record of the preset apparatus corresponding to the apparatus identifier;
sending the encrypted authorization message to the mobile device; and
renewing the first public key by the second public key.

3. The apparatus management method according to claim 1, wherein after determining whether the first indicator is received when the at least one selectable schedule exists, the apparatus management method further comprises:
updating the reservation record of each of the at least one preset apparatus in the selectable schedule indicated by the first indicator according to the user information when the first indicator is received.

4. The apparatus management method according to claim 3, wherein receiving the user information and the indicated project at the schedule reservation stage comprises:
receiving a reserved time and a reserved position;
wherein the at least one executable item corresponds to an execution time, and determining whether there is the at least one selectable schedule corresponding to the at least one executable item according to the reservation record of the at least one preset apparatus comprises:
determining whether the at least one selectable schedule according to the reserved time exists, according to the reserved position and the execution time of the at least one executable item;
wherein when the first indicator is received, updating the reservation record of the at least one preset apparatus in the selectable schedule indicated by the first indicator according to the user information comprises:
updating the reservation record of the at least one preset apparatus in the selectable schedule indicated by the first indicator according to the reserved time, the reserved position and the execution time of the at least one executable item.

5. The apparatus management method according to claim 4, further comprising:
providing an operation interface from which the indicated project, the reserved time, the reserved position and the first indicator are received.

6. The apparatus management method according to claim 5, wherein before updating the reservation record of the at least one preset apparatus in the selectable schedule indicated by the first indicator according to the user information is performed, the apparatus management method further comprises:
displaying the at least one preset apparatus corresponding to the at least one executable item on the operation interface according to an apparatus recommend order.

7. The apparatus management method according to claim 6, wherein before the indicated project is received, the apparatus management method further comprises:
displaying a plurality of selectable projects on the operation interface;
determining a second indicator for indicating one of the plurality of selectable projects is received through the operation interface; and
setting the selectable project indicated by the second indicator to be the indicated project when the second indicator is received through the operation interface.

8. An apparatus management device applied to a server and comprising:
a schedule reservation module configured to receive user information and a indicated project at a schedule reservation stage and determine whether at least one selectable schedule related to at least one executable item exists, according to a reservation record of at least one preset apparatus, and when the at least one selectable schedule exists, determine whether a first indicator for indicating one of the at least one selectable schedule is received, wherein the indicated project is related to at least one executable item and at least one preset apparatus, the at least one executable item is in executive order, the at least one executable item in the indicated project corresponds to the at least one preset apparatus, and the at least one executable item in each selectable schedule corresponds to one of the at least one preset apparatus; and
an apparatus authorization module coupled to the schedule reservation module and configured to at a schedule execution stage, adaptively authorize the at least one preset apparatus in the selectable schedule indicated by the first indicator according to a current time, the user information and the reservation record of the at least one preset apparatus in the selectable schedule indicated by the first indicator.

9. The apparatus management device according to claim 8, wherein the user information is related to a mobile device identifier of a mobile device;
the apparatus authorization module receives an encrypted identification message and the mobile device identifier of the mobile device from the mobile device, encrypts the encrypted identification message using a first public key to obtain an apparatus identifier and a second public key, and reads out the selectable schedule, which is indicated by the first indicator and related to the mobile device identifier, to determine whether the apparatus identifier matches one of the at least one preset apparatus in the selectable schedule indicated by the first indicator;
when the apparatus identifier matches one of the at least one preset apparatus in the selectable schedule indicated by the first indicator, the apparatus authorization module determines whether to authorize the preset apparatus corresponding to the apparatus identifier according to the mobile device identifier, the current time, and the reservation record corresponding to the apparatus identifier;
when it is determined to authorize the preset apparatus corresponding to the apparatus identifier, the apparatus authorization module encrypts the apparatus identifier and a service time using the second public key to generate an encrypted authorization message, sends the encrypted authorization message to the mobile device, and renews the first public key by the second public key; and
the service time is related to the reservation record of the preset apparatus corresponding to the apparatus identifier.

10. The apparatus management device according to claim 8, wherein the schedule reservation module updates the reservation record of the at least one preset apparatus in the selectable schedule indicated by the first indicator according to the user information when the first indicator is received.

11. The apparatus management device according to claim 10, wherein the schedule reservation module receives a reserved time and a reserved position;
the at least one executable item corresponds to an execution time, the schedule reservation module, according to the reserved time, the reserved position and the execution time of the at least one executable item, determines whether the at least one selectable schedule exists; and
the schedule reservation module, according to the reserved time, the reserved position and the execution time of the at least one executable item, updates the reservation record of the at least one preset apparatus in the selectable schedule indicated by the first indicator.

12. The apparatus management device according to claim 11, wherein the schedule reservation module provides an operation interface from which the indicated project, the reserved time, the reserved position and the first indicator are received.

13. The apparatus management device according to claim 12, wherein the schedule reservation module, according to an apparatus recommend order, displays the at least one preset apparatus corresponding to the at least one executable item on the operation interface.

14. The apparatus management device according to claim 13, wherein the schedule reservation module displays a plurality of selectable projects on the operation interface and determines whether a second indicator is received through the operation interface; and when the second indicator for indicating one of the plurality of selectable projects is received through the operation interface, the selectable project indicated by the second indicator is set as the indicated project.

15. An apparatus management method applied to a mobile device and comprising:
at a schedule reservation stage, logging in a server using user information to select a indicated project related to at least one executable item and at least one preset apparatus, the at least one executable item being in executive order, and in the indicated project, the at least one executable item corresponding to the at least one preset apparatus;
sending a first indicator to select one of at least one selectable schedule corresponding to the indicated project, and the at least one executable item in each selectable schedule corresponding to one of the at least one preset apparatus;
at a schedule execution stage, sending a starting request to an apparatus to determine whether the apparatus is authorized to start because of matching the selectable schedule indicated by the first indicator; and
operating the apparatus by the mobile device when the apparatus is authorized to start because of matching the selectable schedule indicated by the first indicator.

16. The apparatus management method according to claim 15, wherein the user information is related to a mobile device identifier of the mobile device, and at the schedule execution stage, sending the starting request to the apparatus to determine whether the apparatus is authorized to start because of matching the selectable schedule indicated by the first indicator comprises:
from the apparatus receiving an encrypted identification message corresponding to the starting request;
sending the encrypted identification message and the mobile device identifier to the server;
receiving an encrypted authorization message corresponding to the encrypted identification message from the server; and
sending the encrypted authorization message to the apparatus;
wherein when the apparatus is authorized by the server because of matching the selectable schedule indicated by the first indicator, the apparatus starts in response to the encrypted authorization message.

17. The apparatus management method according to claim 15, wherein at the schedule reservation stage, using the user information to log in the server to select the indicated project comprises:
selecting a reserved time and a reserved position;
wherein the at least one selectable schedule is related to the reserved time, the reserved position and an execution time of the at least one executable item.

18. The apparatus management method according to claim 17, wherein at the schedule reservation stage, logging in the server using the user information to select the indicated project further comprises:
using the user information to log in an operation interface of the server, wherein the indicated project, the reserved time, the reserved position and the first indicator are selected by the operation interface and are received by the server.

19. The apparatus management method according to claim 18, wherein the at least one preset apparatus corresponding to the at least one executable item is displayed on the operation interface according to an apparatus recommend order.

20. The apparatus management method according to claim 19, wherein at the schedule reservation stage, using the user information to log in the server to select the indicated project further comprises:
sending a second indicator through the operation interface to set one of a plurality of selectable projects to be the indicated project, wherein the plurality of selectable projects is displayed on the operation interface.

21. A non-transitory computer readable storage media in which a program for performing the apparatus management method of claim 15 is stored.

22. An apparatus management method for an apparatus, comprising:
receiving a starting request from a mobile device;
in response to the starting request, using the mobile device to communicate with a server in order to determine whether the apparatus matches a selectable schedule indicated by a first indicator; and
Starting the apparatus when the apparatus matches the selectable schedule indicated by the first indicator;
wherein the first indicator is received by the server in order to indicate the selectable schedule, the selectable schedule indicated by the first indicator is related to at least one executable item, the at least one executable item is in executive order, and the at least one executable item corresponds to at least one preset apparatus.

23. The apparatus management method according to claim 22, wherein in response to the starting request, using the mobile device to communicate with the server in order to determine whether the apparatus matches the selectable schedule indicated by the first indicator, comprises:
randomly generating a second private key and a second public key;
encrypting a first apparatus identifier of the apparatus and the second public key using a first private key to generate an encrypted identification message corresponding to the starting request;
sending the encrypted identification message to the server through the mobile device;
determining whether an encrypted authorization message corresponding to the encrypted identification message is received from the mobile device;
decrypting the encrypted authorization message using the second private key to read out a second apparatus identifier and a service time when the encrypted authorization message corresponding to the encrypted identification message is received from the mobile device;
determining whether the second apparatus identifier matches the first apparatus identifier;
Starting the apparatus according to the service time related to a reservation record of the apparatus when the second apparatus identifier is the same as the first apparatus identifier; and
renewing the first private key by the second private key.

24. An apparatus management device for an apparatus, comprising:
a near field communication module configured to receive a starting request from a mobile device and in response to the starting request, communicate with a server through the mobile device;
an authority determination module coupled to the near field communication module and configured to according to a communication result, determine whether the apparatus matches a selectable schedule indicated by a first indicator, and when the apparatus matches the selectable schedule indicated by the first indicator, generate an enabling signal; and
an apparatus enabling module coupled to the authority determination module and configured to start the apparatus when receiving the enabling signal;
wherein the first indicator is received by the server in order to indicate the selectable schedule, the selectable schedule indicated by the first indicator is related to at least one executable item, the at least one executable item is in executive order, and the at least one executable item corresponds to a preset apparatus.

25. The apparatus management device according to claim 24, wherein the authority determination module randomly generates a second private key and a second public key, encrypts a first apparatus identifier of the apparatus and the second public key using a first private key to generate an encrypted identification message;
the authority determination module sends the encrypted identification message to the mobile device then transferring the encrypted identification message to the server through the near field communication module;
the authority determination module determines whether an encrypted authorization message corresponding to the encrypted identification message is received from the mobile device;
when the encrypted authorization message corresponding to the encrypted identification message is received from the mobile device, the authority determination module decrypts the encrypted authorization message using the second private key to read out a second apparatus identifier and a service time;
the authority determination module determines whether the second apparatus identifier matches the first apparatus identifier; and
when the second apparatus identifier is the same as the first apparatus identifier, the authority determination module generates the enabling signal according to the service time related to a reservation record of the apparatus so that the apparatus enabling module starts the apparatus according to the enabling signal and the authority determination module renews the first private key by the second private key.
